(19) United States
(12) Patent Application Publication
(10) Pub. No.: US 2017/0171456 A1
(43) Pub. Date: Jun. 15, 2017

(54) Stereo Autofocus

(71) Applicant: Google Inc., Mountain View, CA (US)

(72) Inventor: Jianing Wei, Mountain View, CA (US)

(21) Appl. No.: 14/965,575

(22) Filed: Dec. 10, 2015

(51) Int. Cl. H04N 5/232; H04N 13/02; G06T 7/00

(52) U.S. Cl. CPC H04N 5/23212; G06T 7/0075; H04N 13/0239; G06T 2207/10012; G06T 2207/20228

(57) ABSTRACT

A first image capture component may capture a first image of a scene, and a second image capture component may capture a second image of the scene. There may be a particular baseline distance between the first image capture component and the second image capture component, and at least one of the first image capture component or the second image capture component may have a focal length. A disparity may be determined between a portion of the scene as represented in the first image and the portion of the scene as represented in the second image. Possibly based on the disparity, the particular baseline distance, and the focal length, a focus distance may be determined. The first image capture component and the second image capture component may be set to focus to the focus distance.

### BACKGROUND

Digital cameras have focusable lenses usable to capture sharp images that accurately represent the details within a scene. Some of these cameras provide manual focus controls. Many cameras, however, such those as in wireless computing devices (e.g., smartphones and tablets) use automatic focus (autofocus or AF) algorithms to relieve the user of the burden of having to manually focus the camera for each scene.

Existing autofocus technologies capture an image, estimate the sharpness of the captured image, adjust the focus accordingly, capture another image, and so on. This process may be repeated for several iterations. The final, sharpest image is stored and/or displayed to the user. As a consequence, autofocus procedures take time, and during that time the scene may have moved, or the sharpness may be difficult to estimate given the current scene conditions.

A stereo camera, such as a smartphone with two or more image capture components, can simultaneously capture multiple images, one with each image capture component. The stereo camera or a display device can then combine these images in some fashion to create or simulate a three-dimensional (3D), stereoscopic image. But, existing autofocus techniques do not perform well on stereo cameras. In addition to the delays associated with iterative autofocus, if each individual image capture component carries out an autofocus procedure independently, the individual image capture components may end up with incompatible focuses. As a result, the stereoscopic image may be blurry.

### SUMMARY

The embodiments herein disclose a stereo autofocus technique that can be used to rapidly focus multiple image capture components of a camera. Rather using the iterative approach of single-camera autofocus, the techniques herein may directly estimate a focus distance for the image capture components. As a result, each image capture component may be focused at the same distance, where that focus distance is selected to create reasonable sharp images across all of the image capture components. Based on this focus distance, each image capture component may capture an image, and these images may be used to form into a stereoscopic image.

Accordingly, in a first example embodiment, a first image capture component may capture a first image of a scene, and a second image capture component may capture a second image of the scene. There may be a particular baseline distance between the first image capture component and the second image capture component, and at least one of the first image capture component or the second image capture component may have a focal length. A disparity may be determined between a portion of the scene as represented in the first image and the portion of the scene as represented in the second image. Possibly based on the disparity, the particular baseline distance, and the focal length, a focus distance may be determined. The first image capture component and the second image capture component may be set to focus to the focus distance. The first image capture component, focused to the focus distance, may capture a third image of a scene, and the second image capture component, focused to the focus distance, may capture a fourth image of the scene. The third image and the fourth image may be combined to form a stereo image of the scene.

In a second example embodiment, an article of manufacture may include a non-transitory computer-readable medium, having stored thereon program instructions that, upon execution by a computing device, cause the computing device to perform operations in accordance with the first example embodiment.

In a third example embodiment, a computing device may include at least one processor, as well as data storage and program instructions. The program instructions may be stored in the data storage, and upon execution by the at least one processor may cause the computing device to perform operations in accordance with the first example embodiment.

In a fourth example embodiment, a system may include various means for carrying out each of the operations of the first example embodiment.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1A depicts front and right side views of a digital camera device, according to example embodiments.

FIG. 1B depicts rear views of a digital camera device, according to example embodiments.

FIG. 2 depicts a block diagram of a computing device with image capture capability, according to example embodiments.

FIG. 3 depicts stereo imaging, according to example embodiments.

FIG. 4 depicts the lens position of an image capture component, according to example embodiments.

FIG. 5 depicts determining the distance between an object and two cameras, according to example embodiments.

FIG. 6 depicts a mapping between focus distance and focal values, according to example embodiments.

FIG. 7 is a flow chart, according to example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

In the description herein, embodiments involving a single stereoscopic camera device with two image capture components, or two camera devices operating in coordination with one another, are disclosed. These embodiments, however, are presented for purpose of example. The techniques described herein may be applied to stereoscopic camera devices with arrays of two or more (e.g., four, eight, etc.) image capture components. Further, these techniques may also be applied to two or more stereoscopic or non-stereoscopic cameras each with one or more image capture components. Moreover, in some implementations, the image processing steps described herein may be performed by a stereoscope camera device, while in other implementations, the image processing steps may be performed by a computing device in communication with (and perhaps controlling) one or more camera devices.

Depending on context, a “camera” may refer to an individual image capture component, or a device that contains one or more image capture components. In general, image capture components include an aperture, lens, recording surface, and shutter, as described below.

### 1. EXAMPLE IMAGE CAPTURE DEVICES

As cameras, become more popular, they may be employed as standalone hardware devices or integrated into other types of devices. For instance, still and video cameras are now regularly included in wireless computing devices (e.g., smartphones and tablets), laptop computers, video game interfaces, home automation devices, and even automobiles and other types of vehicles.

An image capture component of a camera may include one or more apertures through which light enters, one or more recording surfaces for capturing the images represented by the light, and one or more lenses positioned in front of each aperture to focus at least part of the image on the recording surface(s). The apertures may be fixed size or adjustable. In an analog camera, the recording surface may be photographic film. In a digital camera, the recording surface may include an electronic image sensor (e.g., a charge coupled device (CCD) or a complementary metal-oxide-semiconductor (CMOS) sensor) to transfer and/or store captured images in a data storage unit (e.g., memory).

One or more shutters may be coupled to or nearby the lenses or the recording surfaces. Each shutter may either be in a closed position, in which it blocks light from reaching the recording surface, or an open position, in which light is allowed to reach to recording surface. The position of each shutter may be controlled by a shutter button. For instance, a shutter may be in the closed position by default. When the shutter button is triggered (e.g., pressed), the shutter may change from the closed position to the open position for a period of time, known as the shutter cycle. During the shutter cycle, an image may be captured on the recording surface. At the end of the shutter cycle, the shutter may change back to the closed position.

Alternatively, the shuttering process may be electronic. For example, before an electronic shutter of a CCD image sensor is “opened,” the sensor may be reset to remove any residual signal in its photodiodes. While the electronic shutter remains open, the photodiodes may accumulate charge. When or after the shutter closes, these charges may be transferred to longer-term data storage. Combinations of mechanical and electronic shuttering may also be possible.

Regardless of type, a shutter may be activated and/or controlled by something other than a shutter button. For instance, the shutter may be activated by a softkey, a timer, or some other trigger. Herein, the term “image capture” may refer to any mechanical and/or electronic shuttering process that results in one or more images being recorded, regardless of how the shuttering process is triggered or controlled.

The exposure of a captured image may be determined by a combination of the size of the aperture, the brightness of the light entering the aperture, and the length of the shutter cycle (also referred to as the shutter length or the exposure length). Additionally, a digital and/or analog gain may be applied to the image, thereby influencing the exposure.

A still camera may capture one or more images each time image capture is triggered. A video camera may continuously capture images at a particular rate (e.g., 24 images—or frames—per second) as long as image capture remains triggered (e.g., while the shutter button is held down). Some digital still cameras may open the shutter when the camera device or application is activated, and the shutter may remain in this position until the camera device or application is deactivated. While the shutter is open, the camera device or application may capture and display a representation of a scene on a viewfinder. When image capture is triggered, one or more distinct digital images of the current scene may be captured.

Cameras with more than one image capture component may be referred to as stereoscopic cameras. A stereoscopic camera can simultaneously, or nearly simultaneously, capture two or more images, one with each image capture component. These images may be used to form into a 3D stereoscopic image that represents the depth of objects in a scene.

Cameras may include software to control one or more camera functions and/or settings, such as aperture size, exposure time, gain, and so on. Additionally, some cameras may include software that digitally processes images during or after when these images are captured.

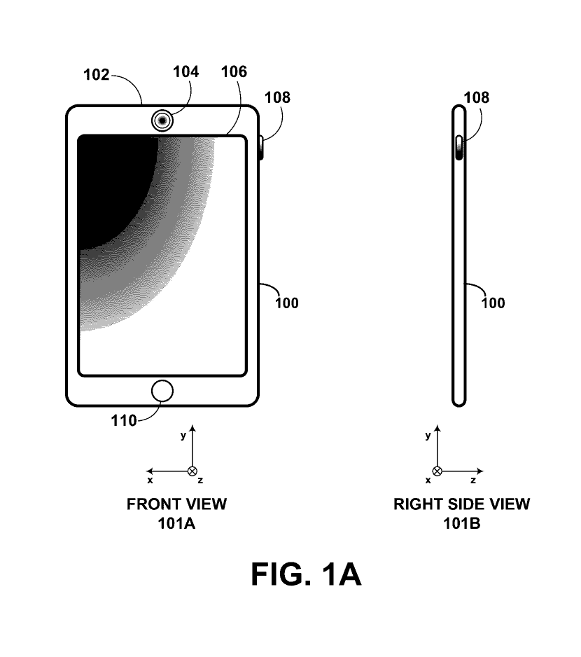

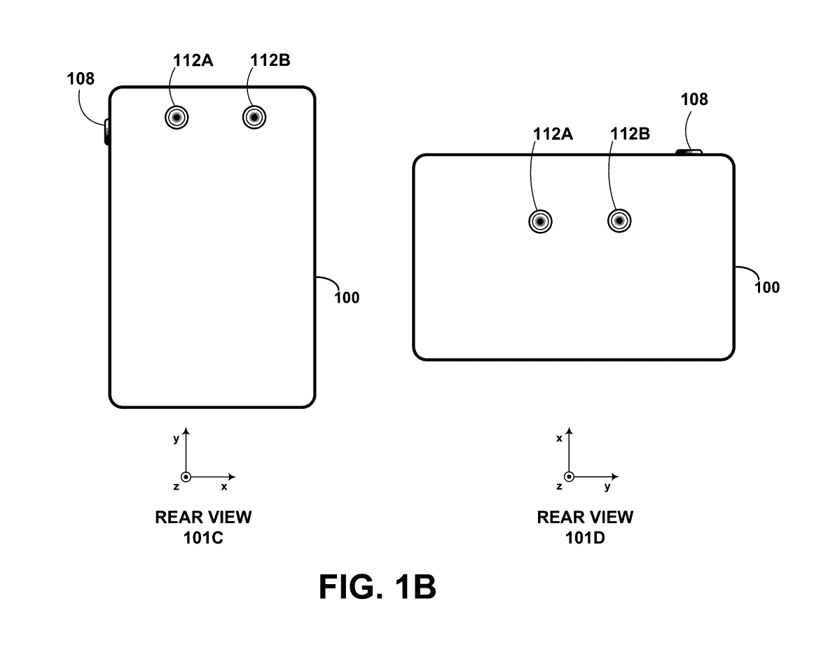

As noted previously, digital cameras may be standalone devices or integrated with other devices. As an example, FIG. 1A illustrates the form factor of a digital camera device 100 as seen from front view 101A and side view 101B. Digital camera device 100 may be, for example, a mobile phone, a tablet computer, or a wearable computing device. However, other embodiments are possible.

Digital camera device 100 may include various elements, such as a body 102, a front-facing camera 104, a multi-element display 106, a shutter button 108, and other buttons 110. Front-facing camera 104 may be positioned on a side of body 102 typically facing a user while in operation, or on the same side as multi-element display 106.

As depicted in FIG. 1B, digital camera device 100 could further include rear-facing cameras 112A and 112B. These cameras may be positioned on a side of body 102 opposite front-facing camera 104. Rear views 101C and 101D show two alternate arrangements of rear-facing cameras 112A and 112B. In both arrangements, the cameras are positioned in a plane, and at the same point on either the x-axis or y-axis. Nonetheless, other arrangements are possible. Also, referring to the cameras as front facing or rear facing is arbitrary, and digital camera device 100 may include multiple cameras positioned on various sides of body 102.

Multi-element display 106 could represent a cathode ray tube (CRT) display, a light emitting diode (LED) display, a liquid crystal (LCD) display, a plasma display, or any other type of display known in the art. In some embodiments, multi-element display 106 may display a digital representation of the current image being captured by front-facing camera 104 and/or rear-facing cameras 112A and 112B, or an image that could be captured or was recently captured by any one or more of these cameras. Thus, multi-element display 106 may serve as a viewfinder for the cameras. Multi-element display 106 may also support touchscreen and/or presence-sensitive functions that may be able to adjust the settings and/or configuration of any aspect of digital camera device 100.

Front-facing camera 104 may include an image sensor and associated optical elements such as lenses. Front-facing camera 104 may offer zoom capabilities or could have a fixed focal length. In other embodiments, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent a monoscopic camera, for example.

Rear-facing cameras 112A and 112B may be arranged as a stereo pair. Each of these cameras may be a distinct, independently-controllable image capture component, including an aperture, lens, recording surface, and shutter. Digital camera device 100 may instruct rear-facing cameras 112A and 112B to simultaneously capture respective monoscopic images of a scene, and may then use a combination of these monoscopic images to form a stereo image with depth.

Either or both of front facing camera 104 and rear-facing cameras 112A and 112B may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover 3D models from an object are possible within the context of the embodiments herein.

One or more of front facing camera 104, and/or rear-facing cameras 112A and 112B, may include or be associated with an ambient light sensor that may continuously or from time to time determine the ambient brightness of a scene that the camera can capture. In some devices, the ambient light sensor can be used to adjust the display brightness of a screen associated with the camera (e.g., a viewfinder). When the determined ambient brightness is high, the brightness level of the screen may be increased to make the screen easier to view. When the determined ambient brightness is low, the brightness level of the screen may be decreased, also to make the screen easier to view as well as to potentially save power. The ambient light sensor may also be used to determine an exposure times for image capture.

Digital camera device 100 could be configured to use multi-element display 106 and either front-facing camera 104 or rear-facing cameras 112A and 112B to capture images of a target object. The captured images could be a plurality of still images or a video stream. The image capture could be triggered by activating shutter button 108, pressing a softkey on multi-element display 106, or by some other mechanism. Depending upon the implementation, the images could be captured automatically at a specific time interval, for example, upon pressing shutter button 108, upon appropriate lighting conditions of the target object, upon moving digital camera device 100 a predetermined distance, or according to a predetermined capture schedule.

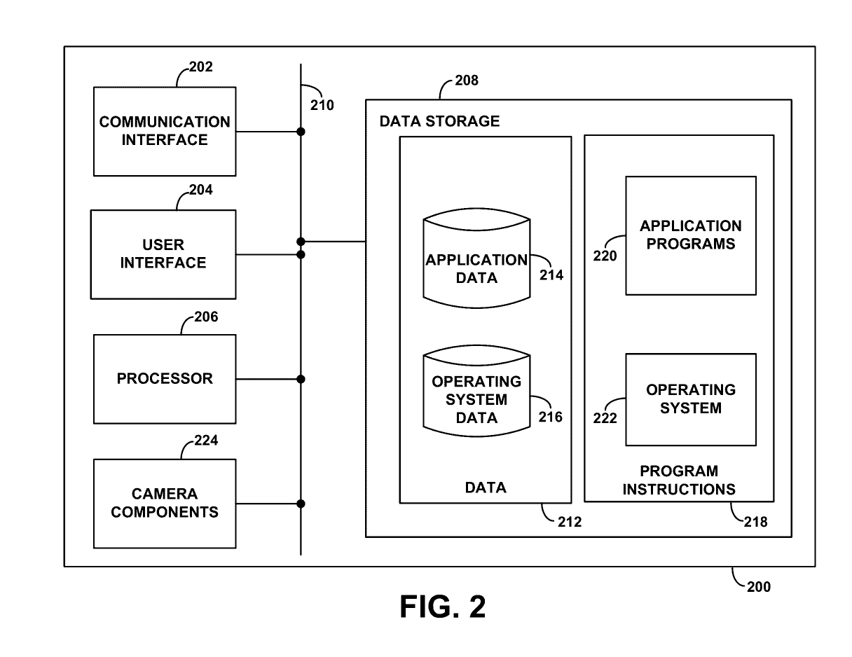

As noted above, the functions of digital camera device 100—or another type of digital camera—may be integrated into a computing device, such as a wireless computing device, cell phone, tablet computer, laptop computer and so on. For purposes of example, FIG. 2 is a simplified block diagram showing some of the components of an example computing device 200 that may include camera components 224.

By way of example and without limitation, computing device 200 may be a cellular mobile telephone (e.g., a smartphone), a still camera, a video camera, a fax machine, a computer (such as a desktop, notebook, tablet, or handheld computer), a personal digital assistant (PDA), a home automation component, a digital video recorder (DVR), a digital television, a remote control, a wearable computing device, or some other type of device equipped with at least some image capture and/or image processing capabilities. It should be understood that computing device 200 may represent a physical camera device such as a digital camera, a particular physical hardware platform on which a camera application operates in software, or other combinations of hardware and software that are configured to carry out camera functions.

As shown in FIG. 2, computing device 200 may include a communication interface 202, a user interface 204, a processor 206, data storage 208, and camera components 224, all of which may be communicatively linked together by a system bus, network, or other connection mechanism 210.

Communication interface 202 may allow computing device 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port. Communication interface 202 may also take the form of or include a wireless interface, such as a Wifi, BLUETOOTH®, global positioning system (GPS), or wide-area wireless interface (e.g., WiMAX or 3GPP Long-Term Evolution (LTE)). However, other forms of physical layer interfaces and other types of standard or proprietary communication protocols may be used over communication interface 202. Furthermore, communication interface 202 may comprise multiple physical communication interfaces (e.g., a Wifi interface, a BLUETOOTH® interface, and a wide-area wireless interface).

User interface 204 may function to allow computing device 200 to interact with a human or non-human user, such as to receive input from a user and to provide output to the user. Thus, user interface 204 may include input components such as a keypad, keyboard, touch-sensitive or presence-sensitive panel, computer mouse, trackball, joystick, microphone, and so on. User interface 204 may also include one or more output components such as a display screen which, for example, may be combined with a presence-sensitive panel. The display screen may be based on CRT, LCD, and/or LED technologies, or other technologies now known or later developed. User interface 204 may also be configured to generate audible output(s), via a speaker, speaker jack, audio output port, audio output device, earphones, and/or other similar devices.

In some embodiments, user interface 204 may include a display that serves as a viewfinder for still camera and/or video camera functions supported by computing device 200. Additionally, user interface 204 may include one or more buttons, switches, knobs, and/or dials that facilitate the configuration and focusing of a camera function and the capturing of images (e.g., capturing a picture). It may be possible that some or all of these buttons, switches, knobs, and/or dials are implemented by way of a presence-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing device 200, cause computing device 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, and/or gaming applications) installed on computing device 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing device 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some vernaculars, application programs 220 may be referred to as “apps” for short. Additionally, application programs 220 may be downloadable to computing device 200 through one or more online application stores or application markets. However, application programs can also be installed on computing device 200 in other ways, such as via a web browser or through a physical interface (e.g., a USB port) on computing device 200.

Camera components 224 may include, but are not limited to, an aperture, shutter, recording surface (e.g., photographic film and/or an image sensor), lens, and/or shutter button. Camera components 224 may be controlled at least in part by software executed by processor 206.

### 2. EXAMPLE STEREO IMAGING AND AUTOFOCUS

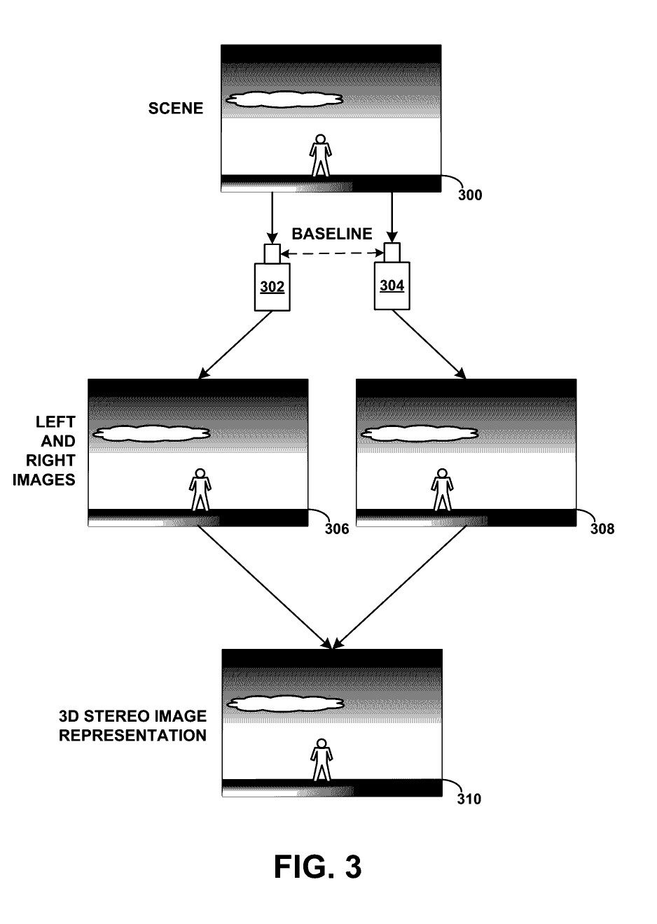

FIG. 3 depicts an example embodiment of stereo imaging. In this figure, left camera 302 and right camera 304 are capturing images of scene 300. Scene 300 includes a person in the foreground and a cloud in the background. Left camera 302 and right camera 304 are separated by a baseline distance.

Each of left camera 302 and right camera 304 may include image capture components, such as respective apertures, lenses, shutters, and recording surfaces. In FIG. 3, left camera 302 and right camera 304 are depicted as distinct physical cameras, but left camera 302 and right camera 304 could be separate sets of image capture components of the same physical digital camera, for example.

Regardless, left camera 302 and right camera 304 may simultaneously capture left image 306 and right image 308, respectively. Herein, such simultaneous image captures may occur at the same time, or within a few milliseconds (e.g., 1, 5, 10, or 25) of one another. Due to the respective positions of left camera 302 and right camera 304, the person in the foreground of scene 300 appears slightly to the right in left image 306 and slightly to the left in right image 308.

Left image 306 and right image 308 may be aligned with one another and then used in combination to form a stereo image representation of scene 300. Image alignment may involve computational methods for arranging left image 306 and right image 308 over one another so that they “match.” One technique for image alignment is global alignment, in which fixed x-axis and y-axis offsets are applied to each pixel in one image so that this image is substantially aligned with the other image. Substantial alignment in this context may be an alignment in which an error factor between the pixels is minimized or determined to be below a threshold value. For instance, a least-squares error may be calculated for a number of candidate alignments, and the alignment with the lowest least squares error may be determined to be a substantial alignment.

However, better results can usually be achieved if one image is broken into a number of m×n pixel blocks, and each block is aligned separately according to respective individual offsets. The result might be that some blocks are offset differently than others. For each candidate alignment of blocks, the net difference between all pixels in the translated source image and the target image may be determined and summed. This net error is stored, and the translation with the minimum error may be selected as a substantial alignment.

Other image alignment techniques may be used in addition to or instead of those described herein.

Additionally, various techniques may be used to create stereo image representation 310 from left image 306 and right image 308. Stereo image representation 310 may be viewable with or without the assistance of 3D glasses. For instance, left image 306 and right image 308 may be superimposed over one another on a screen, and a user may wear 3D glasses that filter the superimposed image so that each of the user's eyes sees an appropriate view. Alternatively, the screen may rapidly (e.g., about every 100 milliseconds) switch between left image 306 and right image 308. This may create a 3D effect without requiring the user to wear 3D glasses.

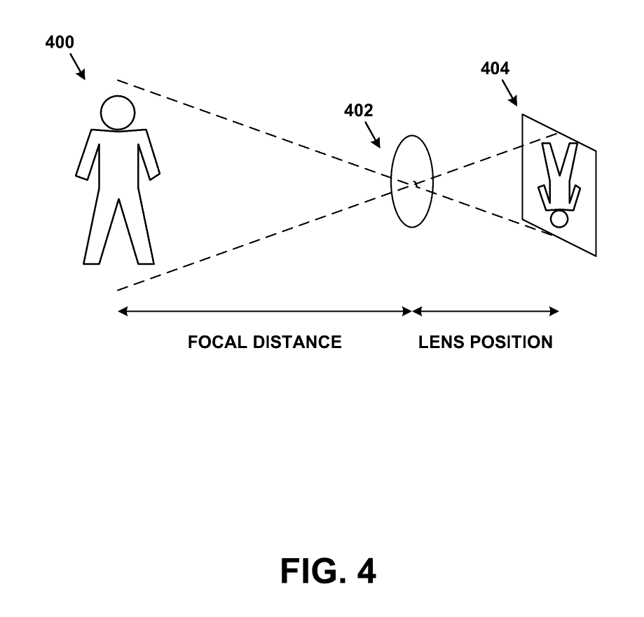

FIG. 4 depicts a simplified representation of an image capture component capturing an image of an object. The image capture component includes a lens 402 and a recording surface 404. Light representing object 400 passes through lens 402 and creates an image of object 400 on recording surface 404 (due to the optics of lens 402, the image on recording surface 404 appears upside down). Lens 402 may be adjustable, in that it can move left or right with respect to FIG. 4. For instance, adjustments may be made by applying a voltage to a motor (not shown in FIG. 4) controlling the position of lens 402. The motor may move lens 402 further from or closer to recording surface 404. Thus, the image capture component can focus on objects at a range of distances. The distance between lens 402 and recording surface 404 at any point in time is known as the lens position, and is usually measured in millimeters. The distance between lens 402 and its area of focus is known as the focus distance, and may be measured in millimeters or other units.

Focal length is an intrinsic property of a lens, and is fixed if the lens is not a zoom lens. The lens position refers to the distance between lens surface and recording surface. The lens position can be adjusted to make objects appear sharp (in focus). In some embodiments, lens position is approximated by focal length—if the lens is driven to focus at infinity, then the lens position is equal to focal length. Thus, focal length is known and fixed for non-zoom image capture components, while lens position is unknown but can be estimated to focus the image capture component on an object.

Autofocus is a methodology used to focus an image capture component with little or no assistance from a user. Autofocus may automatically select an area of a scene on which to focus, or may focus on a pre-selected area of the scene. Autofocus software may automatically adjust the lens position of the image capture component until it determines that the image capture component is sufficiently well-focused on an object.

An example autofocus methodology is described below. This example, however, is just one way of achieving autofocus, and other techniques may be used.

In contrast-based autofocus, the image on the recording surface is digitally analyzed. Particularly, the contrast in brightness between pixels (e.g., the difference between the brightness of the brightest pixel and the least-brightest pixel) is determined. In general, the higher this contrast, the better the image is in focus. After determining the contrast, the lens position is adjusted, and the contrast is measured again. This process repeats until the contrast is at least at some pre-defined value. Once this pre-defined value is achieved, an image of the scene is captured and stored.

There are two distinct disadvantages to the type of autofocus. First, the autofocus algorithm may iterate for some time (e.g., tens or hundreds of milliseconds or more), causing an undesirable delay. During this iterative process, objects in the scene may move. This may result in the autofocus algorithm to continue iterating for even longer. Second, contrast-based autofocus (as well as other autofocus techniques) can be subject to inaccuracies when evaluating low-light scenes or scenes with points of light. For example, when attempting to capture an image of a Christmas tree that has its lights on in a dark room, the contrast between the lights and the rest of the room may “fool” the autofocus algorithm into finding that almost any lens position results in an acceptable focus. This is due to the fact that edges of defocused point light sources are sharp enough to be considered in focus by contrast based autofocus algorithms.

Furthermore, for a stereo camera or any camera device with multiple image capture components, operating autofocus independently on each image capture component may lead to undesirable results. Possibly due to the image capture components being in slightly different positions with respect to objects in a scene, as well as possible hardware differences between the image capture components, each image capture component may end up focusing at different distances. Also, even if one image capture component is used to determine a lens position, this same lens position cannot reliably be used by other image capture components because of the possible hardware differences.

### 3. EXAMPLE NON-ITERATIVE STEREO AUTOFOCUS

The embodiments herein improve upon autofocus techniques. Particularly, a non-iterative autofocus technique that accurately estimates the distance between the image capture components and an object is disclosed. Then, using a component-specific table that maps such distances to voltages, an appropriate voltage can be applied to the motors of each lens so that each image capture component focuses at the same focus distance for image capture.

The embodiments herein assume the presence of multiple image capture components, either in the form of multiple cameras or a single camera. Additionally, for purpose of simplicity, the embodiments herein describe stereo autofocus for two image capture components, but these techniques may be applied to arrays of three or more image capture components as well.

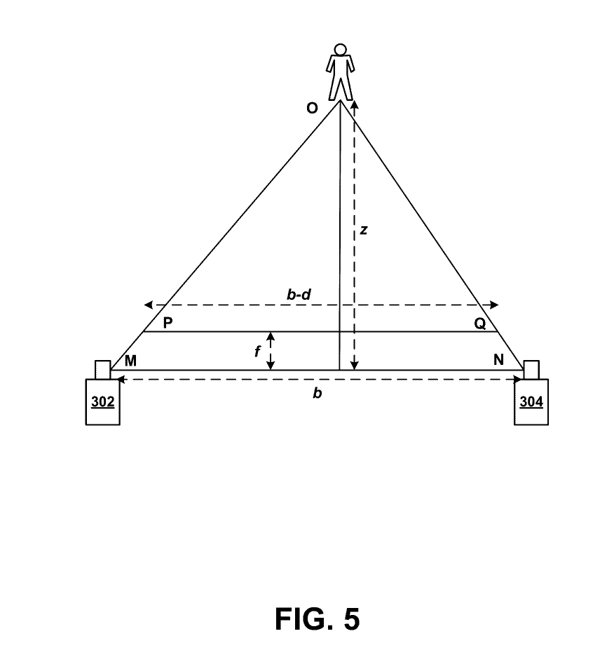

Triangulation based on the locations of two image capture components and an object in a scene can be used to estimate the distance from the image capture components to the object. Turning to FIG. 5, left camera 302 and right camera 304 are assumed to be a distance of b apart from one another on the x-axis. One or both of these cameras has a focal length of f (the position and magnitude of which are exaggerated in FIG. 5 for purpose of illustration). Both cameras are also aimed at an object that is a distance z from the cameras on the z-axis. The values of b and f are known, but the value of z is to be estimated.

One way of doing so is to capture images of the object at both left camera 302 and right camera 304. As noted in the context of FIG. 3, the object will appear slightly to the right in the image captured by left camera 302 and slightly to the left in the image captured by right camera 304. This x-axis distance between the object as it appears in the captured images is the disparity, d.

A first triangle, MNO, can be drawn between left camera 302, right camera 304, and the object. Also, a second triangle, PQO, can be drawn from point P (where the object appears in the image captured by left camera 302) to point Q (where the object appears in the image captured by right camera 304), to point O. The disparity, d, also can be expressed as the distance between point P and point Q.

Formally, triangle MNO and triangle PQO are similar triangles, in that all of their corresponding angles have the same measure. As a consequence, they also have the same ratio of width to height. Therefore:

$$\begin{matrix}\frac{b}{z} = \frac{b - d}{z - f} & ( 1 ) \\ b ( z - f ) = z ( b - d ) & ( 2 ) \\ bz - bf = bz - dz & ( 3 ) \\ - bf = - dz & ( 4 ) \\ z = \frac{bf}{d} & ( 5 )\end{matrix}$$

In this manner, the distance z from the cameras to the object can be directly estimated. The only remaining unknown is the disparity d. But this value can be estimated based on the images of the object captured by left camera 302 and right camera 304.

To that end, a feature that appears in each of these images may be identified. This feature may be the object (e.g., the person in FIG. 5) or may be a different feature. The disparity can be estimated based on the offset in pixels between the feature as it appears in each of the two images.

An alignment algorithm can be used to find this disparity. For instance, an m×n pixel block containing at least part of the feature from one of the two images can be matched to a similarly-sized block of pixels in the other image. In other words, the algorithm may search for the best matching block in the right image for the corresponding block in the left image, or vice versa. Various block sizes may be used, such as 5×5, 7×7, 9×9, 11×11, 3×5, 5×7, and so on.

The search may be done along the epipolar line. In some cases, a multiresolution approach may be used to conduct the search. As described above, the alignment with the least squares error may be found. Alternatively, any alignment in which a measure of error is below a threshold value may be used instead.

Once the alignment is found, the disparity is the number of pixels in the offset between corresponding pixels of the feature in the two images. In cases where the two cameras are aligned on the x-axis, this alignment process can be simplified by just searching along the x-axis. Similarly, if the two cameras are aligned on the y-axis, this alignment process can be simplified by just searching along the y-axis.

In alternative or additional embodiments, a corner (or a similar edge feature) in one of the two images may be matched to the same corner in the other image. A corner detecting algorithm such as the Harris and Stephens technique, or the Features from Accelerated Segment Test (FAST) technique. Then, a transform between corresponding corners can be computed as an affine transform or planar homography using, for instance, the normalized 8-point algorithm and random sample consensus (RANSAC) for outlier detection. The translation component of this transform can then be extracted, and its magnitude is the disparity. This technique may provide a high quality estimate of disparity even without image alignment, but may also be computationally more expensive than aligning the images. Also, since the cameras are usually not focused correctly to start, the corner detection technique might work poorly on resulting blurry images that do not have sharply-defined corners. As a result, downsampling at least some regions of the images and performing corner detection on the downsampled regions may be desirable.

Once the distance z is known, each of the two (or more) cameras can be focused to that distance. Different image capture components, however, may have different settings with which they focus at a particular distance. Thus, the same commands given to both cameras may result in the two cameras focusing at different distances.

In order to address this issue, the focal qualities of each set of image capture component hardware may be mapped through calibration to a focal value within a given range. For purpose of example, the range of 0-100 will be used herein. Thus, a focal value is a unit-less integer value that specifies a lens position within some distance from the recording surface, in accordance with manufacturing tolerances. These values for a particular image capture component may further map to voltages or other mechanisms that cause the image capture component to move its lens to a lens position that results in the image capture component focusing at the distance.

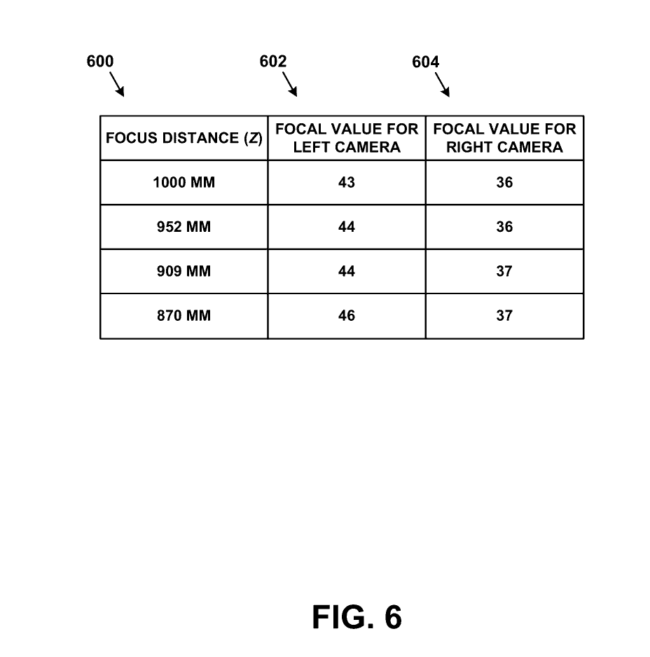

FIG. 6 provides an example mapping between focus distance and focal values from 0-100. Column 600 represents focus distance, column 602 represents focal values for the left camera, and column 604 represents focal values for the right camera. Each entry in the mapping indicates the focal values to which each camera can be set so that these cameras focus at the given focus distance. For example, in order to have both cameras focus at a distance of 909 millimeters, the focal value for the left camera can be set to 44 and the focal value of the right camera can be set to 36.

As noted above, the focal value for a camera (e.g., a set of image capture components) represents a hardware-specific lens position. Thus, each focal value may be associated with a particular voltage, for example, that when applied to the lens, adjusts the lens so that the desired focus distance is achieved. In some cases, the voltage specifies a particular force to apply to the lens, rather than a position. Closed loop image capture components may support this feature by being able to provide status updates from their modules regarding where the lens is and whether it is converged or still moving. In other cases, the focal value specifies a particular location of the lens, as determined by an encoder for instance.

In order to determine the association between focus distances, lens positions, and voltages, each set of image capture components may be calibrated. For example, an object may be moved until it is in sharp focus at each of the image capture component's lens positions, and the distance from the image capture component to that object can be measured for each lens position. Or, put another way, an object is placed at a distance D from the image capture component, then the focal value is adjusted until the image of the object is sufficiently sharp. The focal value V is recorded, and then a mapping between distance D and focal value V is found. To obtain a table of mappings between D and V, the object can be placed in different positions with equal spacing in diopters (inverse of distance).

From this data, the lens positions can be assigned focal values in the 0-100 range. Any such calibration may occur offline (e.g., during manufacture of the camera or during configuration of the stereo autofocus software), and the mapping between focus distance and focal values, as well as the mapping between focal values and lens position, may be provided in a data file.

### 4. EXAMPLE OPERATIONS

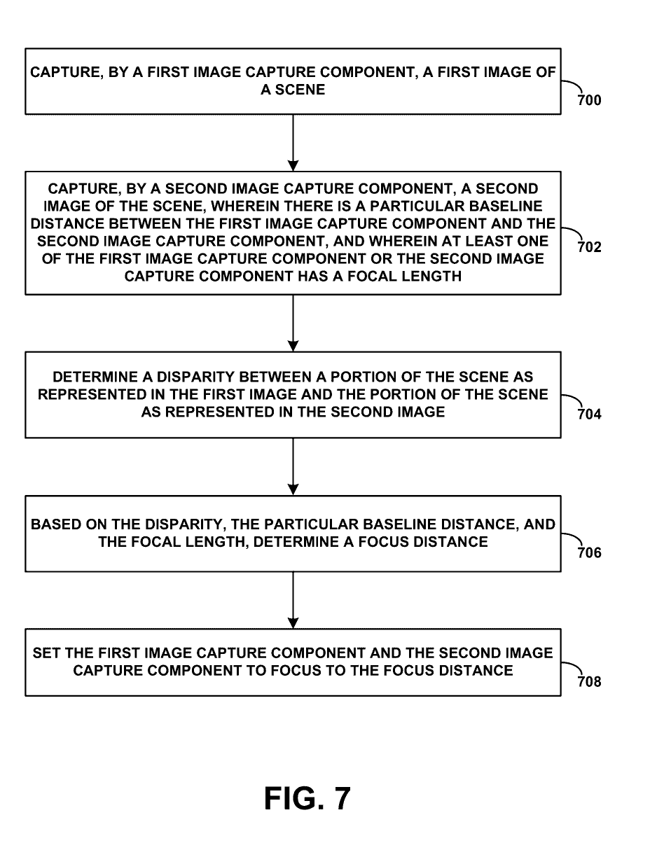

FIG. 7 is a flow chart illustrating an example embodiment. The embodiment illustrated by FIG. 7 may be carried out by a computing device, such as digital camera device 100. However, the embodiment can be carried out by other types of devices or device subsystems. Further, the embodiment may be combined with any aspect or feature disclosed in this specification or the accompanying drawings.

Block 700 of FIG. 7 may involve capturing, by a first image capture component, a first image of a scene. Block 702 may involve capturing, by a second image capture component, a second image of the scene. Each of the first image capture component and the second image capture component may include respective apertures, lenses, and recording surfaces.

Further, there may be a particular baseline distance between the first image capture component and the second image capture component. Also, at least one of the first image capture component or the second image capture component may have a focal length. In some embodiments, the first image capture component and the second image capture component may be parts of a stereo camera device. In other embodiments, the first image capture component and the second image capture component may be parts of separate and distinct camera devices that are coordinated by the way of software and communications therebetween. It is possible for the first image capture component and the second image capture component have the same or different image capture resolutions

Block 704 may involve determining a disparity between a portion of the scene as represented in the first image and the portion of the scene as represented in the second image.

Block 706 may involve, possibly based on the disparity, the particular baseline distance, and the focal length, determining a focus distance. The focus distance may be based on a product of the particular baseline and the focal length divided by the disparity.

Block 708 may involve setting the first image capture component and the second image capture component to focus to the focus distance. Setting the focuses may involve sending respective commands to the first image capture component and the second image capture component to adjust their lens positions so that these components focus to the focus distance.

Although not shown, the embodiment of FIG. 7 may further involve capturing, by the first image capture component focused to the focus distance, a third image of a scene, and capturing, by the second image capture component focused to the focus distance, a fourth image of the scene. The third image and the fourth image may be combined to form and/or display a stereo image of the scene. Such a displayed stereo image might or might not require 3D glasses for viewing.

In some embodiments, determining the disparity between the portion of the scene as represented in the first image and the portion of the scene as represented in the second image involves identifying a first m×n pixel block in the first image and identifying a second m×n pixel block in the second image. The first m×n pixel block or the second m×n pixel block may be shifted until the first m×n pixel block and the second m×n pixel block are substantially aligned. The disparity is based on a pixel distance represented by the shift. In some cases, shifting the first m×n pixel block or the second m×n pixel block may involve shifting the first m×n pixel block or the second m×n pixel block only on an x axis.

Substantial alignment as described herein may be an alignment in which an error factor between the blocks is minimized or determined to be below a threshold value. For instance, a least-squares error may be calculated for a number of candidate alignments, and the alignment with the lowest least squares error may be determined to be a substantial alignment.

In some embodiments, the portion of the scene may include a feature with a corner. In these cases, determining the disparity between the portion of the scene as represented in the first image and the portion of the scene as represented in the second image may involve detecting the corner in the first image and the second image, and warping the first image or the second image to the other according to a translation so that the corner in the first image and the second image substantially matches. The disparity may be based on a pixel distance represented by the translation.

In some embodiments, the focal value is an integer selected from a particular range of integer values. The integer values in the particular range may be respectively associated with voltages. These voltages, when applied to the first image capture component and the second image capture component, may cause the first image capture component and the second image capture component to focus approximately at the portion of the scene. Setting the first image capture component and the second image capture component to focus to the focus distance may involve applying a voltage associated with the focus distance to each of the first image capture component and the second image capture component.

In some embodiments, before the first image and the second image are captured, the respective associations between the integer values in the particular range and the voltages may be calibrated based on characteristics of the first image capture component and the second image capture component.

### 5. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

Additionally, any enumeration of elements, blocks, or steps in this specification or the claims is for purpose of clarity. Thus, such enumeration should not be interpreted to require or imply that these elements, blocks, or steps adhere to a particular arrangement or are carried out in a particular order.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
capturing, by a first image capture component of a stereo camera, a first image of a scene;
capturing, by a second image capture component of the stereo camera, a second image of the scene, wherein there is a particular baseline distance between the first image capture component and the second image capture component, and wherein at least one of the first image capture component or the second image capture component has a focal length;
determining a disparity between a portion of the scene as represented in the first image and the portion of the scene as represented in the second image;
based on the disparity, the particular baseline distance, and the focal length, determining a focus distance; and
setting the first image capture component and the second image capture component to focus to the focus distance.

2. The method of claim 1 comprising:
capturing, by the first image capture component focused to the focus distance, a third image of a scene;
capturing, by the second image capture component focused to the focus distance, a fourth image of the scene; and
using a combination of the third image and the fourth image to form a stereo image of the scene.

3. The method of claim 1, wherein determining the disparity between the portion of the scene as represented in the first image and the portion of the scene as represented in the second image comprises:
identifying a first m×n pixel block in the first image;
identifying a second m×n pixel block in the second image; and
shifting the first m×n pixel block or the second m×n pixel block until the first m×n pixel block and the second m×n pixel block are substantially aligned, wherein the disparity is based on a pixel distance represented by the shift.

4. The method of claim 3, wherein shifting the first m×n pixel block or the second m×n pixel block comprises shifting the first m×n pixel block or the second m×n pixel block only on an x axis.

5. The method of claim 1, wherein the portion of the scene includes a feature with a corner, and wherein determining the disparity between the portion of the scene as represented in the first image and the portion of the scene as represented in the second image comprises:
detecting the corner in the first image and the second image; and
warping the first image or the second image to the other according to a translation so that the corner in the first image and the second image substantially matches, wherein the disparity is based on a pixel distance represented by the translation.

6. The method of claim 1, wherein the first image capture component and the second image capture component have different image capture resolutions.

7. The method of claim 1, wherein the focus distance is based on a product of the particular baseline and the focal length divided by the disparity.

8. The method of claim 1, wherein the focal value is an integer value selected from a particular range of integer values, wherein the integer values in the particular range are respectively associated with voltages, and wherein the voltages, when applied to the first image capture component and the second image capture component, cause the first image capture component and the second image capture component to focus approximately at the portion of the scene.

9. The method of claim 8, wherein setting the first image capture component and the second image capture component to focus to the focus distance comprises applying a voltage associated with the focus distance to each of the first image capture component and the second image capture component.

10. The method of claim 8, further comprising:
before capturing the first image and the second image, calibrating the respective associations between the integer values in the particular range and the voltages based on characteristics of the first image capture component and the second image capture component.

11. The method of claim 1, wherein each of the first image capture component and the second image capture component comprises respective apertures, lenses, and recording surfaces.

12. An article of manufacture including a non-transitory computer-readable medium, having stored thereon program instructions that, upon execution by a computing device, cause the computing device to perform operations comprising:
capturing, by a first image capture component, a first image of a scene;
capturing, by a second image capture component, a second image of the scene, wherein there is a particular baseline distance between the first image capture component and the second image capture component, and wherein at least one of the first image capture component or the second image capture component has a focal length;
determining a disparity between a portion of the scene as represented in the first image and the portion of the scene as represented in the second image;
based on the disparity, the particular baseline distance, and the focal length, determining a focus distance; and
setting the first image capture component and the second image capture component to focus to the focus distance.

13. The article of manufacture of claim 12, wherein the operations further comprise:
capturing, by the first image capture component focused to the focus distance, a third image of a scene;
capturing, by the second image capture component focused to the focus distance, a fourth image of the scene; and
combining the third image and the fourth image to form a stereo image of the scene.

14. The article of manufacture of claim 12, wherein determining the disparity between the portion of the scene as represented in the first image and the portion of the scene as represented in the second image comprises:
identifying a first m×n pixel block in the first image;
identifying a second m×n pixel block in the second image; and
shifting the first m×n pixel block or the second m×n pixel block until the first m×n pixel block and the second m×n pixel block are substantially aligned, wherein the disparity is based on a pixel distance represented by the shift.

15. The article of manufacture of claim 12, wherein the portion of the scene includes a feature with a corner, and wherein determining the disparity between the portion of the scene as represented in the first image and the portion of the scene as represented in the second image comprises:
detecting the corner in the first image and the second image; and
warping the first image or the second image to the other according to a translation so that the corner in the first image and the second image substantially matches, wherein the disparity is based on a pixel distance represented by the translation.

16. The article of manufacture of claim 12, wherein the focus distance is based on a product of the particular baseline and the focal length divided by the disparity.

17. The article of manufacture of claim 12, wherein the focal value is an integer value selected from a particular range of integer values, wherein the integer values in the particular range are respectively associated with voltages, and wherein the voltages, when applied to the first image capture component and the second image capture component, cause the first image capture component and the second image capture component to focus approximately at the portion of the scene.

18. The article of manufacture of claim 17, wherein setting the first image capture component and the second image capture component to focus to the focus distance comprises applying a voltage associated with the focus distance to each of the first image capture component and the second image capture component.

19. The article of manufacture of claim 12, wherein the operations further comprise:
before capturing the first image and the second image, calibrating the respective associations between the integer values in the particular range and the voltages based on characteristics of the first image capture component and the second image capture component.

20. A computing device comprising:
a first image capture component;
a second image capture component;
at least one processor;
memory; and
program instructions, stored in the memory, that upon execution by the at least one processor cause the computing device to perform operations comprising:
capturing, by the first image capture component, a first image of a scene;
capturing, by the second image capture component, a second image of the scene, wherein there is a particular baseline distance between the first image capture component and the second image capture component, and wherein at least one of the first image capture component or the second image capture component has a focal length;
determining a disparity between a portion of the scene as represented in the first image and the portion of the scene as represented in the second image;
based on the disparity, the particular baseline distance, and the focal length, determining a focus distance; and
setting the first image capture component and the second image capture component to focus to the focus distance.
